(19) United States
(12) Patent Application Publication
(10) Pub. No.: US 2022/0158681 A1
(43) Pub. Date: May 19, 2022

(54) PROTECTIVE CASES FOR MOBILE DEVICES

(71) Applicant: Vinci Brands LLC, Irvine, CA (US)

(72) Inventor: Andy Fathollahi, Corona Del Mar, CA (US)

(73) Assignee: Vinci Brands LLC, Tustin, CA (US)

(21) Appl. No.: 17/649,679

(22) Filed: Feb. 1, 2022

Related U.S. Application Data
(63) Continuation-in-part of application No. 17/448,205, filed on Sep. 20, 2021.
Application No. 17/448,205 is a continuation of application No. 17/316,675, filed on May 10, 2021, now abandoned.
Application No. 17/316,675 is a continuation of application No. 17/103,917, filed on Nov. 24, 2020, now abandoned.
Application No. 17/103,917 is a continuation-in-part of application No. 14/292,497, filed on May 30, 2014, now Pat. No. 10,848,194.
Application No. 14/292,497 is a continuation of application No. 12/540,316, filed on Aug. 12, 2009, now Pat. No. 8,800,762.
Application No. 12/540,316 is a continuation-in-part of application No. 17/448,206, filed on Sep. 20, 2021.
Application No. 17/448,206 is a continuation of application No. 17/316,693, filed on May 10, 2021, now abandoned.
Application No. 17/316,693 is a continuation of application No. 16/835,290, filed on Mar. 30, 2020, now abandoned.
Application No. 16/835,290 is a continuation-in-part of application No. 15/673,277, filed on Aug. 9, 2017, now abandoned.
Application No. 15/673,277 is a continuation of application No. 15/063,464, filed on Mar. 7, 2016, now Pat. No. 9,768,819.
Application No. 15/063,464 is a continuation of application No. 14/585,148, filed on Dec. 29, 2014, now Pat. No. 9,281,858.
(60) Provisional application No. 61/923,631, filed on Jan. 3, 2014.

(51) Int. Cl. H04B 1/3888

(52) U.S. Cl. CPC H04B 1/3888; A45C 2011/003; Y10T 29/49826

(57) ABSTRACT

A protective case for a mobile device having a multi-layered construction is disclosed herein. In some embodiments, the protective case has two layers, which may include a flexible inner sleeve for conformingly surrounding the mobile device and a rigid shell for engaging the flexible inner sleeve. In some alternate embodiments, the protective case has three layers, which may include a back surface layer, an internal liner layer, and a perimeter bumper layer.

### CROSS-REFERENCE TO RELATED APPLICATIONS

This application is a continuation-in-part of U.S. patent application Ser. No. 17/448,205, filed on Sep. 20, 2021, which is a continuation of U.S. patent application Ser. No. 17/316,675, filed on May 10, 2021, which is a continuation of U.S. patent application Ser. No. 17/103,917, filed on Nov. 24, 2020, which is a continuation-in-part of U.S. patent application Ser. No. 14/292,497, filed on May 30, 2014 and issued as U.S. Pat. No. 10,848,194 on Nov. 24, 2020, which is a continuation of U.S. patent application Ser. No. 12/540,316, filed on Aug. 12, 2009 and issued as U.S. Pat. No. 8,800,762 on Aug. 12, 2014; and this application is also a continuation-in-part of U.S. patent application Ser. No. 17/448,206, filed on Sep. 20, 2021, which is a continuation of U.S. patent application Ser. No. 17/316,693, filed on May 10, 2021, which is a continuation of U.S. patent application Ser. No. 16/835,290, filed on Mar. 30, 2020, which is a continuation-in-part of U.S. patent application Ser. No. 15/673,277, filed on Aug. 9, 2017, which is a continuation of U.S. patent application Ser. No. 15/063,464, filed on Mar. 7, 2016 and issued as U.S. Pat. No. 9,768,819 on Sep. 19, 2017, which is a continuation of U.S. patent application Ser. No. 14/585,148, filed on Dec. 29, 2014 and issued as U.S. Pat. No. 9,281,858 on Mar. 8, 2016, which claims the benefit of and priority to U.S. Provisional Patent Application Ser. No. 61/923,631, filed on Jan. 3, 2014; the entireties of which are hereby incorporated herein by reference.

### BACKGROUND

### Field of the Invention

The present disclosure relates to user removable protective cases for mobile devices.

### Description of the Related Art

Mobile devices, such as smartphones, tablets, laptops, and the like are known to sustain damage from impact and from contamination as a result of the ingress of water or other fluids. Such damage may result, for example, in a cracked screen, scratches on a finished surface, lost or damaged buttons or controls, cracked or bent external body components, and/or failed or malfunctioning electrical components. Protective cases can protect mobile devices from such damage and other types of damage.

There remains a continuing need for improved protective cases for mobile devices.

### SUMMARY

A protective case for a mobile device having a multi-layered construction is disclosed herein. The protective case is configured to receive, retain, and protect a mobile device. The protective case includes a front face and a back face that define the height of the mobile device, a perimeter defined by top-end, bottom end, right, and left sides residing between the front and back faces, and corners defined at the intersecting regions of the sides. The case may be for a mobile device that is in the form of a tablet, a mobile or smart phone, an MP3 audio player, a gaming device, or another portable handheld electronic device and may have one or more touchscreens, including on its front face and/or back face.

In a first set of embodiments, the protective case has two layers. In such embodiments, the protective case includes a flexible inner sleeve for conformingly surrounding the mobile device and a rigid shell for engaging the flexible inner sleeve.

In some embodiments within the first set of embodiments, the flexible inner sleeve has a screen aperture and a plurality of indents, the screen aperture is configured such that the flexible inner sleeve cam receive the mobile device through the screen aperture, and the rigid shell has a plurality of fingers, where each finger engages a corresponding indent on the flexible inner sleeve.

In some embodiments within the first set of embodiments, the flexible inner sleeve includes a screen aperture and at least one protrusion for manipulating a mobile device control or knob. The screen aperture is configured such that the flexible inner sleeve can receive the mobile device through the screen aperture. The flexible inner sleeve has a plurality of secondary apertures, where each secondary aperture is aligned with a respective mobile device connection port to allow connecting the mobile device to an auxiliary device. The rigid shell receives the flexible infer sleeve to form an integrated protective case. The rigid shell also includes a plurality of apertures which align with the secondary apertures of the inner sleeve. The inner sleeve or the rigid shell may be used independently to protect a mobile device, or alternatively, the inner sleeve and the rigid shell may be combined to provide an integrated protective unit for the mobile device.

In some embodiments within the first set of embodiments, the protective case is a sleeve that includes a sheath having a backing and a plurality of edges. The sleeve has a face portion and a backing portion, the sleeve defines a first protrusion and a second protrusion which respectively correspond to a first control and a second control of the mobile device, where the sheath engagingly receives the sleeve between the plurality of edges, and where the sheath includes a first cavity and a second cavity for receiving the first protrusion and the second protrusion, respectively.

In a second set of embodiments, the case may be formed of a multilayered construction that includes three layers. The first layer is defined by inner and outer surfaces and dimensioned to cover a portion of the back face of the mobile device and/or extend around a portion of the perimeter of the mobile device at the back face boundary. The inner surface of the first layer includes a plurality of protrusions that extend in a direction generally away from the outer surface.

In embodiments within the second set of embodiments, the second layer is defined by inner and outer surfaces and is also dimensioned to cover a portion of the back face of the mobile device and extend around a portion of the perimeter of the mobile device at the back face boundary. The second layer may further include a plurality of corner protrusions positioned along the perimeter region of the second layer to correspond in location with the corners of the mobile device. The second layer may further include an elevated pattern of interconnected walls extending from its inner surface a height above and in a direction away or opposite from the second layer's outer surface. The second layer further includes a plurality of apertures extending into its outer surface that surround (e.g., in close and firm proximity or contact with) one or more of the protrusions of a first group of protrusions of the first layer. The second and/or first layers may each be configured to cover the entire, a majority, half, or less than half of the back face of the mobile device and may be configured to extend around the entire, a majority, half, or less than half of the perimeter of the mobile device at the back face boundary.

In embodiments within the second set of embodiments, the third layer is similarly defined by third inner and outer surfaces and is dimensioned to cover a portion of the top-end, bottom-end, right, and/or left sides of the mobile device. The third layer may include one or more indentations in its inner surface at the corners. The indentations may be in the reverse image of, or otherwise dimensioned to receive, one or more of the corner protrusions of the second layer. The third layer may also include control apertures that are dimensioned and positioned to allow access to control buttons or ports on the mobile device.

In some embodiments within the second set of embodiments, the first, second, and third layers may be co-molded to form an integrated construction. The first layer may be made of a first material that has a first hardness, the second layer may be made of a second material that has a second hardness, and the third layer may be made of a third material that has a third hardness. The first hardness is greater than the third hardness, and the third hardness is greater than the second hardness.

For example, the first layer may have a Shore A durometer hardness that is 40% or more greater than the third layer, 30% or more greater than the third layer, 20% or more greater than the third layer, or 10% or more greater than the third layer all ±5% as measured using the American Society for Testing and Materials (ASTM) standard D2240. The second layer may have a Shore A durometer hardness of 45±10, 45±5, or 45 as measured using the American Society for Testing and Materials (ASTM) standard D2240. The third layer may have a Shore A durometer hardness of 65±10, 65±5, or 65 as measured using the American Society for Testing and Materials (ASTM) standard D2240. The third layer may also, for example, have a Shore A durometer hardness that is 40% or more greater than the second layer, 30% or more greater than the second layer, 20% or more greater than the second layer, or 10% or more greater than the second layer all ±5% as measured using the American Society for Testing and Materials (ASTM) standard D2240.

In some embodiments within the second set of embodiments, the first, second, and third layers may be formed of a composition comprised of one or more materials including but not limited to polycarbonate (PC), thermoplastic urethane (TPU), thermoplastic elastomer (TPE), acrylonitrile butadiene styrene (ABS), nylon, metal, silicone rubber, or any combination thereof. For example, the first layer, which is the hardest of the three layers, may be formed of a composition comprised of polycarbonate, a combination of polycarbonate and ABS, nylon, fiber-reinforced plastic, and/or metal. The second layer, which is the softest of the three layers, may be formed for example of a composition comprised of TPE, silicone rubber, or combination thereof or other suitable materials. The third layer, which has a hardness between the hardness the other two layers, may be formed for example of a composition that has a relatively high resistance to scratching such as a composition comprised of TPU and/or TPE or a combination thereof or another suitable material.

Thus, in use, when there is an impact at the corners, the third layer, which has a high resistance to scratching and a higher hardness than the second layer, distributes the force of impact and, to the extent the energy of the force is transferred to the second layer, the second layer dampens the shock, especially at the impact prone corners, to thereby mitigate the transfer of the impact energy to the device.

In some embodiments within the second set of embodiments, one or more of the plurality of protrusions of the first layer may have a first external shape selected from a group consisting of a square, an octagon, a pentagon, a rectangle, a triangle, a circle, a hexagon, and a heptagon. Also, one or more of the plurality of protrusions may include an aperture residing within the protrusion that defines a first shape selected from a group consisting of a square, an octagon, a pentagon, a rectangle, a triangle, a circle, a hexagon, and a heptagon. Also, the plurality of protrusions in the first layer may be dimensioned to be below, above, or flush with the height of the walls of the second layer that surround the protrusions. Thus, some of the plurality of protrusions in the first layer may be dimensioned to be flush with the height of the interconnected walls in the second layer adjacent thereto, some of the plurality of protrusions may be dimensioned to be below the height of the interconnected walls adjacent thereto, and some of the plurality of protrusions may be dimensioned to be above the height of the interconnected walls adjacent thereto. The plurality of protrusions may be comprised of multiple groups of protrusions with each protrusion in each group being equally or unequally spaced from one another or spaced in a defined pattern. The plurality of protrusions may be comprised of a first group configured to reside closer to the top end or side than the bottom end or side, a second group may be configured to reside closer to the bottom end or side than the top end or side, and a third group may be configured to reside an equal distance from the right and left sides.

In some embodiments within the second set of embodiments, the number of corner protrusions in the second layer may be two, throe, four, or more (depending on the number of corners on the mobile device), each of which is configured to reside at one, some, or all of the corners of the mobile device or any combination of corners thereof. For example, one corner protrusion may be configured to reside at a corner defined in part by the top side of the mobile device and another corner protrusion may be configured to reside at a corner defined in part by the bottom side. By way of another example, one corner protrusion may be configured to reside at a corner defined in part by the right side of the mobile device and another corner protrusion may be configured to reside at a corner defined in part by the left side of the mobile device. By way of yet another example, a first corner protrusion may be configured to reside at a corner defined in part by the top side of the mobile device (e.g., the intersection between the top side and the right or left side), a second corner protrusion may be configured to reside at a corner defined in part by the bottom side (e.g., the intersection between the bottom side and the right or left side), a third corner protrusion may be configured to reside at a corner defined in part by the right side (e.g., the intersection between the right side and the top or bottom side), and a fourth corner protrusion may be configured to reside at a corner defined in part by the left side (e.g., the intersection between the left side and the top or bottom side). Correspondingly dimensioned corner indentations in the inner surface of the third layer may be provided to engagingly surround or receive one, some, or all of the corner protrusions. Thus, some or all of the surfaces that define the indentions on the third layer may be in contact with a corresponding corner protrusion on the second layer.

In some embodiments within the second set of embodiments, the corner protrusions may be configured or dimensioned to reside above, below, or flush with the height of the mobile device in any combination. For example, one of the corner protrusions may be configured to extend above the height of the mobile device and another of the corner protrusions may be configured to be flush with the height of the mobile device. Alternatively, all of the corner protrusions may be configured to be flush with the height of the mobile device or may be configured to reside below the height of the mobile device. One or all of the corner protrusions may also have uniform or varying dimensions in width and thickness between the base and the apex of the protrusion. For example, the corner protrusions may include a thickness defined between the inner and outer surfaces that varies with the height of the protrusion, such as being thicker (or thinner) at the base of the corner protrusion as compared to the thickness closer to the apex of the corner protrusion. By way of another example, the width generally perpendicular to the thickness may be wider (or narrower) at the base of the corner protrusion as compared to width near the apex of the corner protrusion.

In some embodiments within the second set of embodiments, the pattern of elevated interconnected walls of the second layer may be comprised of any arrangement of shapes selected for example from a group consisting of squares, octagons, pentagons, rectangles, triangles, circles, hexagons, heptagons, or a combination thereof. By way of example, the interconnected walls may be comprised of walls that form hexagons or portions thereof, which together create a honeycomb wall pattern. The apertures in the second layer and the plurality of protrusions of the first layer may also be hexagonal in shape and dimensioned to closely or snugly fit or mate together, so that one, some, or all six of the walls that form the mating hexagons are in contact with one another. The pattern of elevated interconnected walls may be contiguous or dis-contiguous, may or may not extend to the perimeter regions of the second layer, may be positioned in discrete regions, or may be spaced apart from one another. Various patterns comprising one or more shapes may be employed alone or in combination with other patterns, such that one region of the inner surface of the second layer may have one pattern and another region of the inner surface of the second layer may have another pattern. The elevated pattern of interconnected walls may be configured in height and construction so as to suspend the back face of the mobile device above the apertures defined by the interconnected walls so that the hack face of the mobile device does not bottom-out on (or become in contact with) the recessed inner surface of the second layer. Although not depicted, a pattern of interconnected walls may also be employed on the inner surface of the third layer to create an air-suspension frame around the mobile device at the perimeter and front face regions of the mobile device as well as the one created by the second layer vis-a-vis the back face region.

In some embodiments within the second set of embodiments, the second layer may further higher comprise one or more button protrusions that are dimensioned and configured to extend within one or more of the control apertures of the third layer. Each button protrusion may or may not be co-molded to the perimeter of the control aperture to form an integrated region therewith and may be configured to reside above or over a user control button on the mobile device such as a volume, power, mute, or other user button.

In some embodiments within the second set of embodiments, the third layer may also include one or more stability tabs configured to extend underneath the back face of the mobile device. The inner surface of the to may be in contact with the outer surface of the second layer, while the outer surface of the tab may be exposed externally. The tab may be received within an aperture on the first layer that opens to the perimeter. The aperture may be configured to reside closer to one end of the mobile device than the other end and may be configured to reside closer to one side of the mobile device than the other side. Alternatively the aperture and tab may be configured to be centrally positioned relative to one or more sides of the mobile device.

In some embodiments within the second set of embodiments, the third layer may also be configured to include a retention rim positioned to reside over the perimeter region of the front face of the mobile device to retain the mobile device within the case. The retention rim may encircle a portion or the entire front face. For example the retention rim may be configured to extend along the top, bottom, left, or right sides of the mobile device or any combination thereof. For example, the rim may extend only in the corner regions or only in regions other than the corner regions, or in a combination of corner and non-corner regions, which may facilitate insertion and removal of the mobile device from the phone. In this respect, the case is configured and constructed with sufficient flexibility to allow the user to install and remove the mobile device within the case without damaging the case or the mobile device.

In some embodiments within the second set of embodiments, the third layer may further comprise One or more button protrusions. Each button protrusion may be configured to reside above or over a user control button on the mobile device such as a volume, power, mute, or other user button. In embodiments where the third layer comprises one or more button protrusions, the second layer preferably will not include button protrusions.

In some embodiments within the second set of embodiments, the second layer may include one or more apertures to allow for functionality and so as to facilitate the intended use of the mobile device. For example, the second layer may include a camera lens aperture that extends therethrough and is configured to reside around the outside of a camera lens window on the hack face of the mobile device. The walls that define the apertures may extend through the first layer and may overlap the outer surface of the third layer. To the extent there is a touchscreen on the back face or other surface region of the mobile device, the second and first layers may have an aperture to allow user interaction with that touchscreen.

Methods of manufacturing a protective case with multilayered construction having three layers that includes one or more of the various foregoing aspects are also disclosed, Manufacturing steps may, for example, include:
(1) co-molding three distinct layers within a mold to form an integrated protective case construct;
(2) molding the first layer defined by first inner and outer surfaces and dimensioned to cover at least a portion of the back face of the mobile device and extend around at least a portion of the perimeter of the mobile device at the back face boundary; where the first layer may be molded to include a first plurality of protrusions extending from its inner surface in a direction away from its outer surface; and where the first layer may be molded of a material that is harder than each of the second and third layers;
(3) co-molding, around the perimeter regions of the first layer, the third layer defined by third inner and outer surfaces and dimensioned to cover one or more regions of the top, bottom, right, and left sides of the mobile device; where the third layer may be further molded to include one or more control apertures dimensioned and positioned to allow access to control buttons or ports on the mobile device; and include indentations in its inner surface at regions configured to reside at the corners of the mobile device, where the indentations are dimensioned to surround corner protrusions of the second layer; and where the third layer may be molded of material that is harder than the second layer; and
(4) co-molding, onto the inner surface of both the first and third layers, the second layer defined by second inner and outer surfaces and dimensioned to cover at least a portion of the back face of the mobile device and extend around at least a portion of the perimeter of the mobile device at the back lace boundary; where the second layer may include a plurality of corner protrusions positioned along the perimeter region of the second layer to correspond in location with corners of the mobile device and dimensioned to extend at, below, or above the height of the mobile device (as measured thereat between the front and back faces); may include a pattern of walls extending from its inner surface a height above and in a direction away from its outer surface that may form any arrangement of shapes selected for example from a group consisting of squares, octagons, pentagons, rectangles, triangles, circles, hexagons, heptagons, or any combination thereof; and may include a plurality of apertures that surround and are in contact with one or more of the protrusions in the first layer.

The various configuration and construction aspects of the component layers described above or otherwise herein (including as illustrated in the drawings) may be included in the molding process of the layer with any of the foregoing steps, or portions of any of the foregoing steps, in any combination without limitation.

Each of the foregoing and various aspects, together with those set forth in the claims and summarized above or otherwise disclosed herein, including the drawings, may be combined to form claims for a device, apparatus, system, method of manufacture, and/or method of use.

### BRIEF DESCRIPTION OF THE DRAWINGS

The figures provided herewith are intended to illustrate but not to limit the invention. Reference numbers are re-used in the figures to indicate correspondence between referenced elements.

FIG. 1 is a perspective view of a conventional mobile device.

FIG. 2A is a perspective view of an embodiment of the disclosed flexible inner sleeve.

FIG. 2B is a perspective view of an embodiment of a rigid shell for use with the flexible inner sleeve of FIG. 2A.

FIG. 3A is a top perspective view of an embodiment of the disclosed flexible inner sleeve.

FIG. 38 is a bottom plan view of the flexible inner sleeve of FIG. 3A.

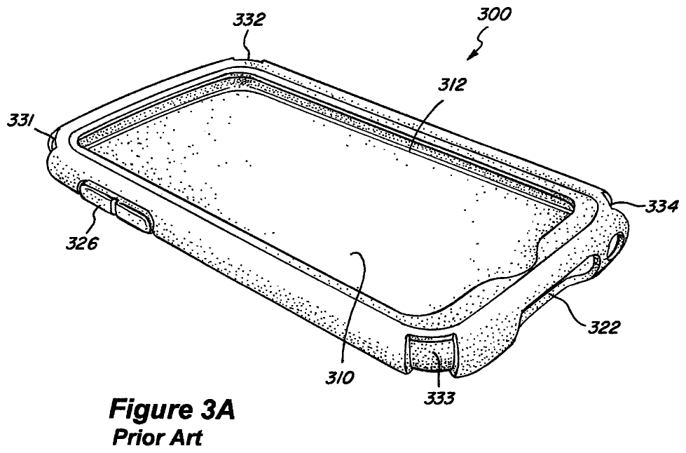

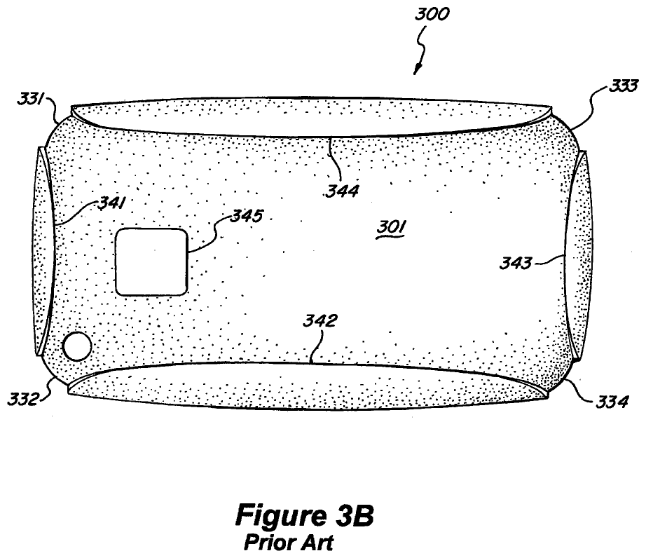

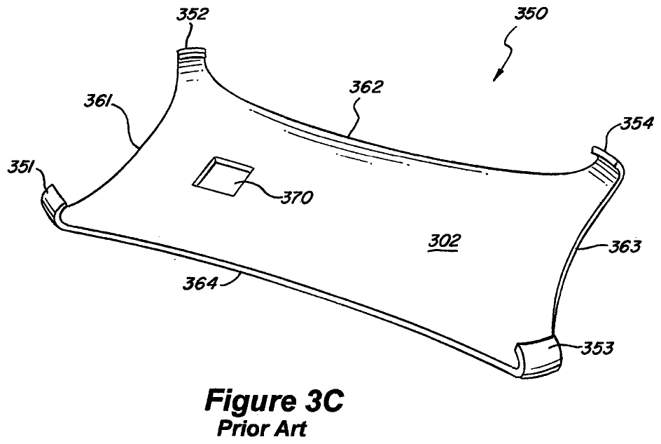

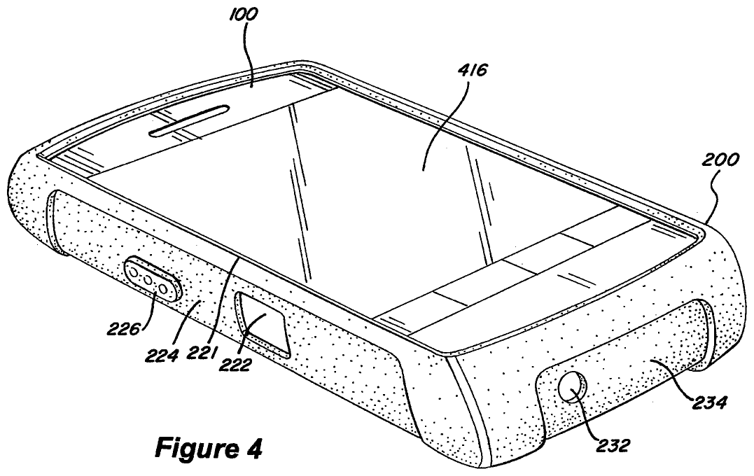

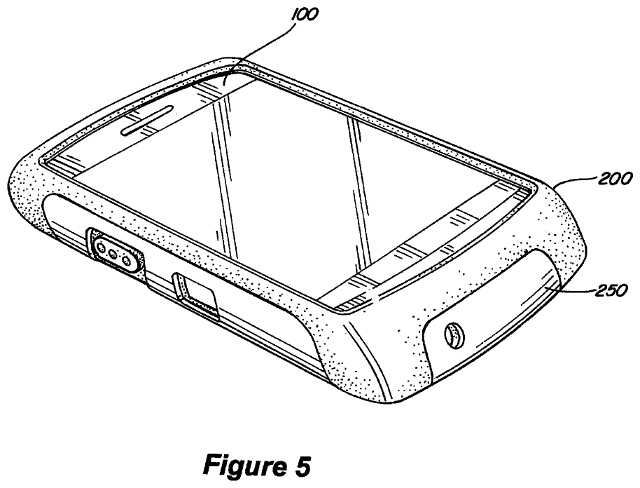

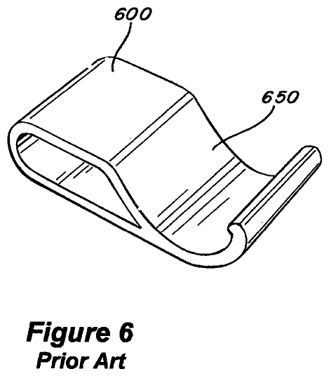

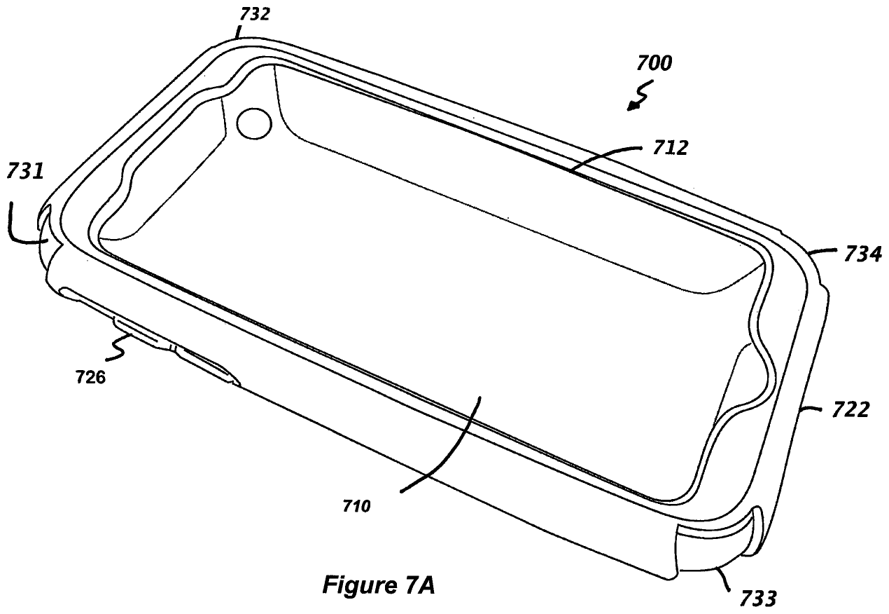

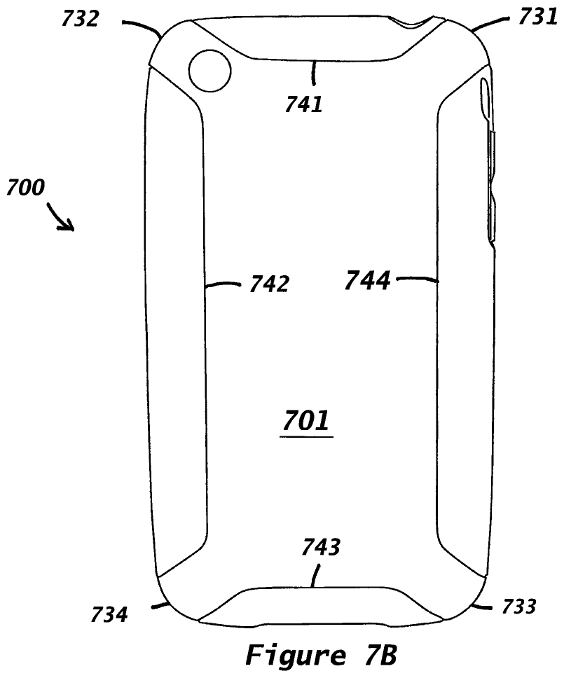

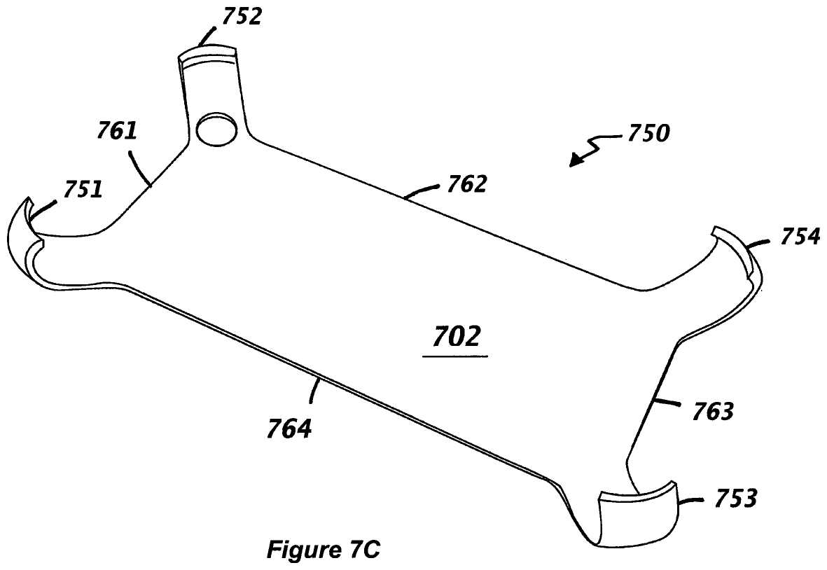

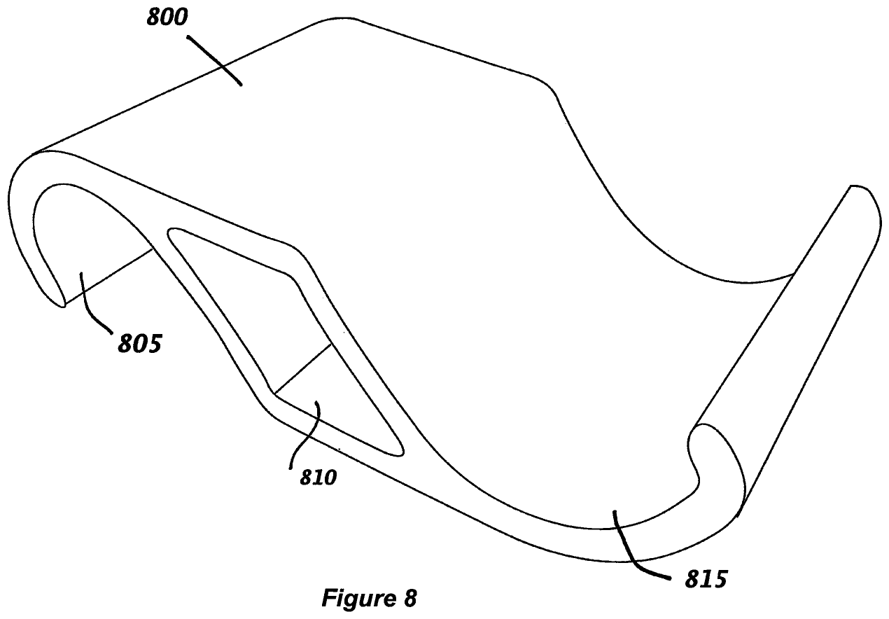

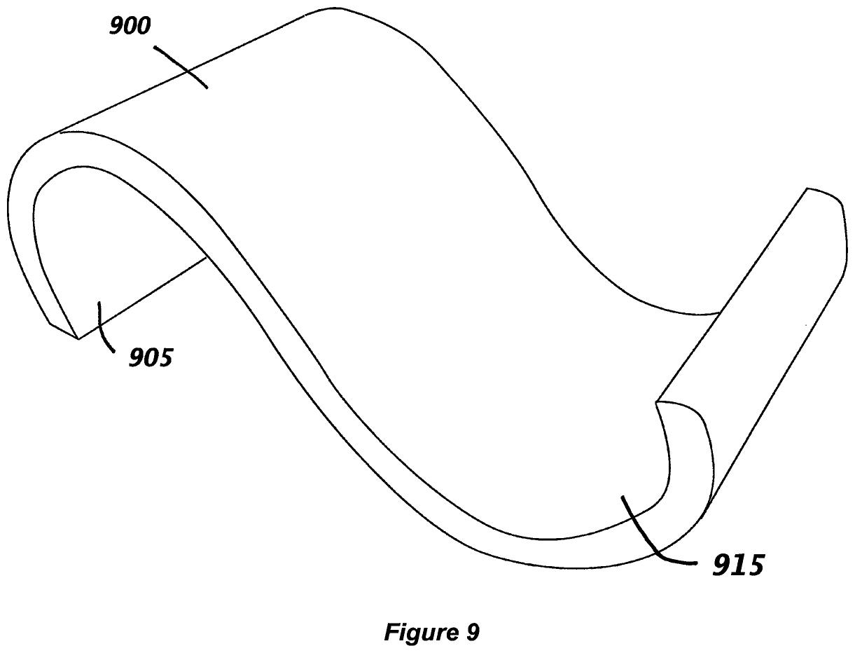

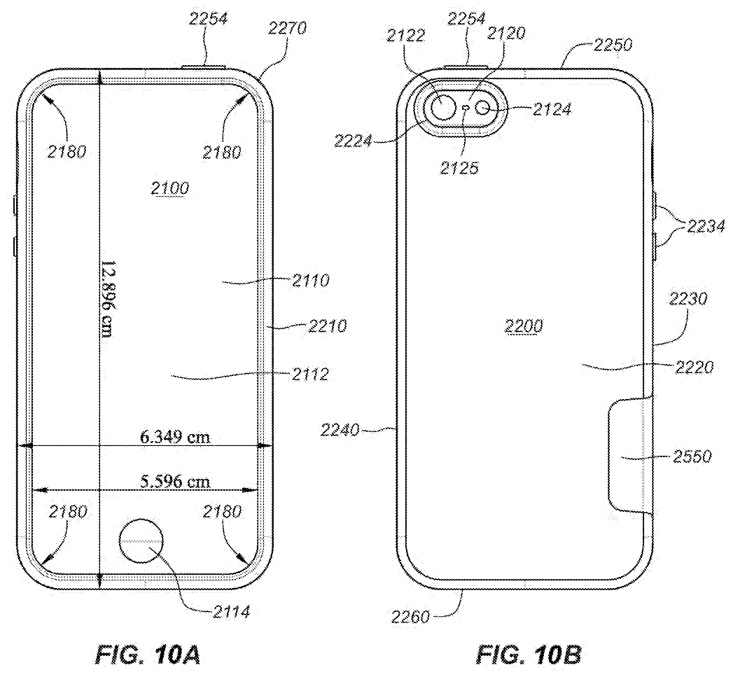

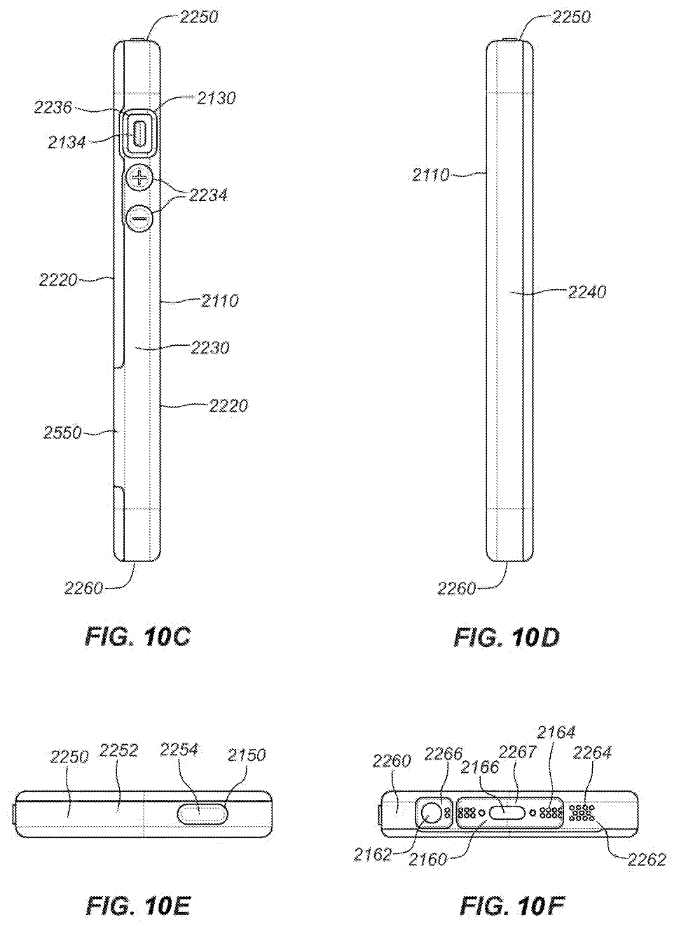

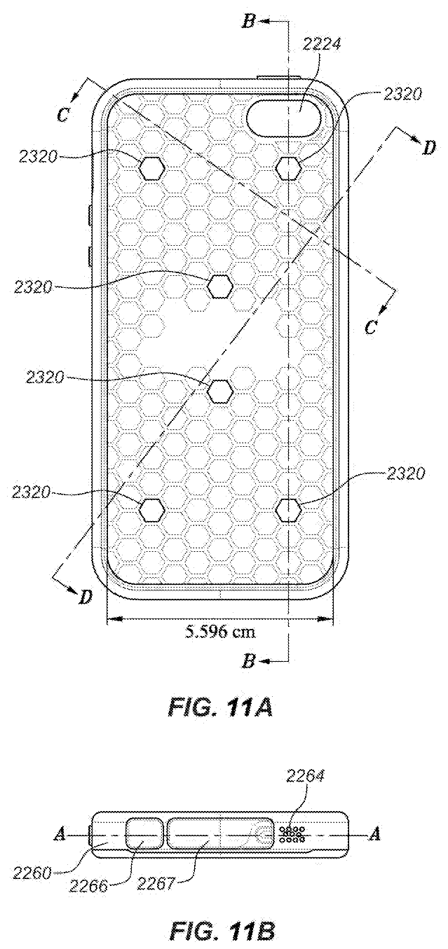

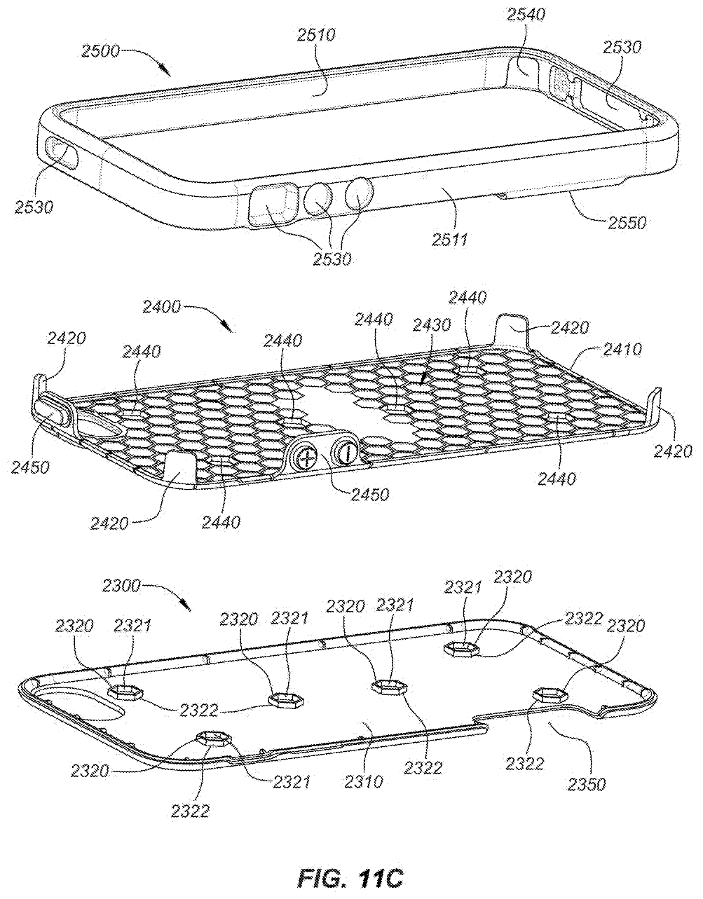

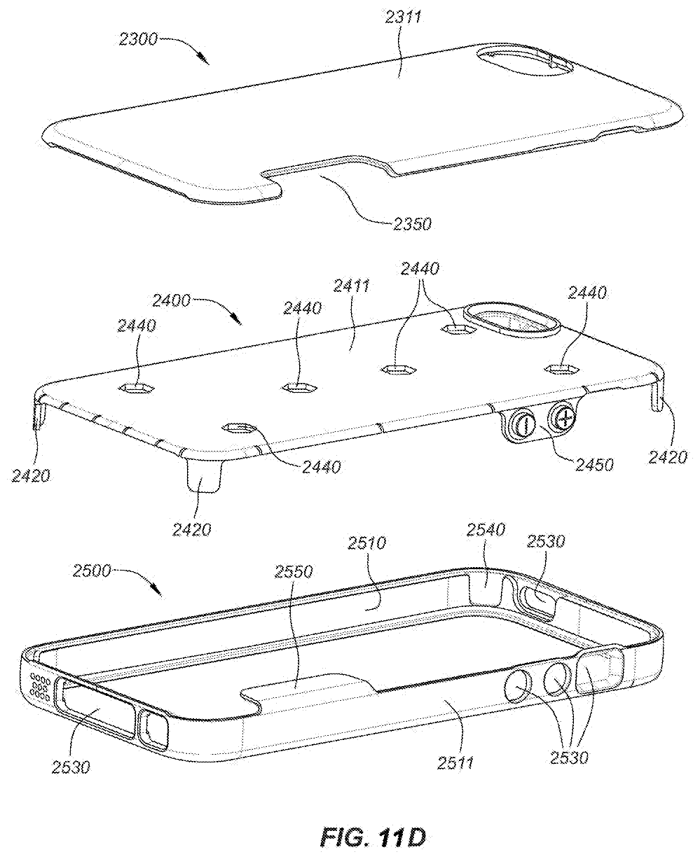

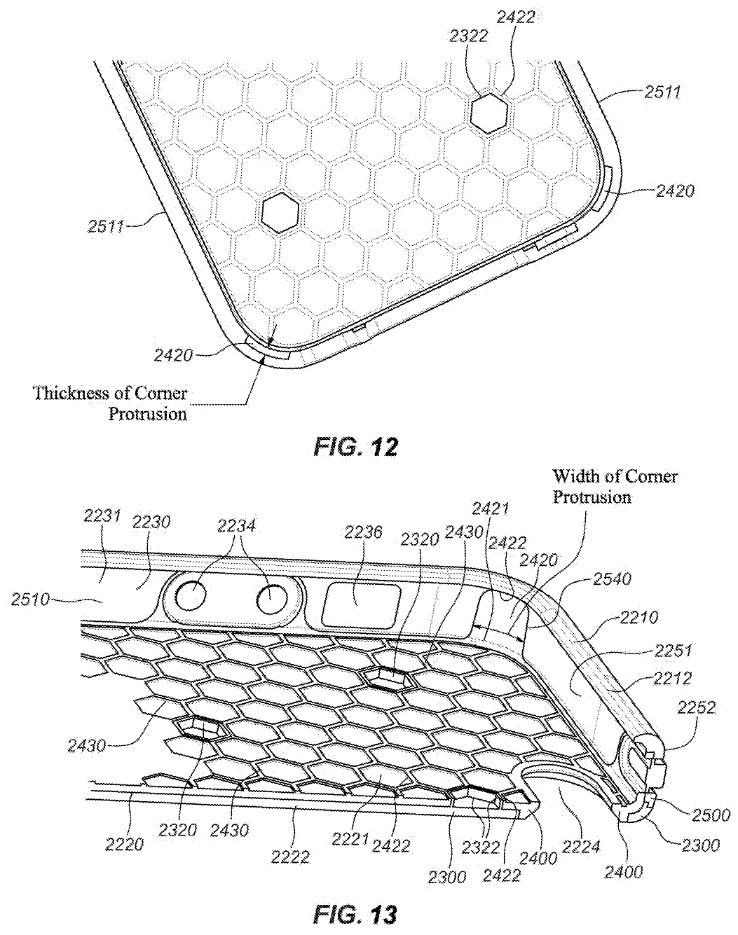

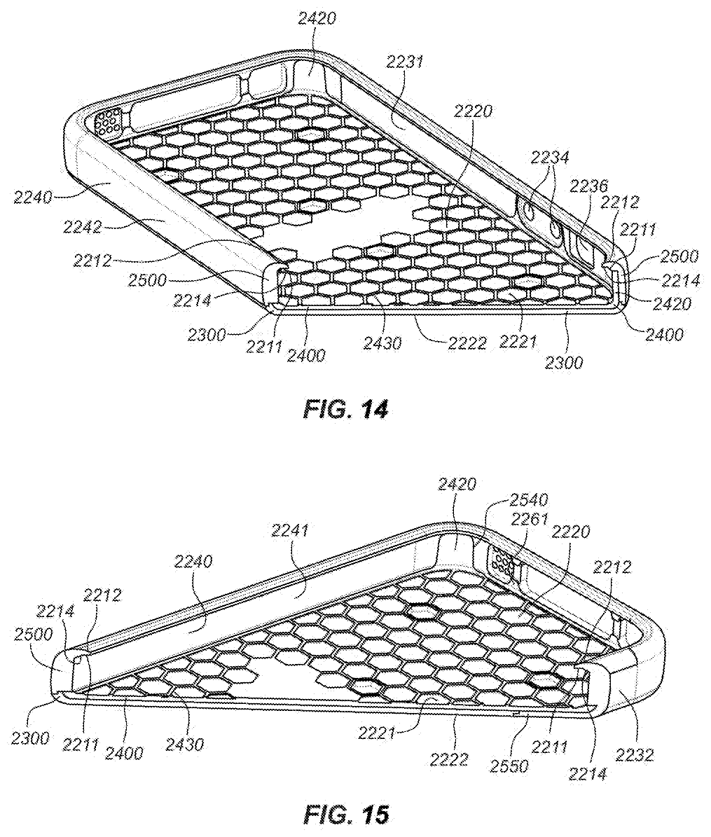

FIG. 3C is a perspective inside view of an embodiment of a rigid shell for use with the flexible inner sleeve of FIGS. 3A and 38.

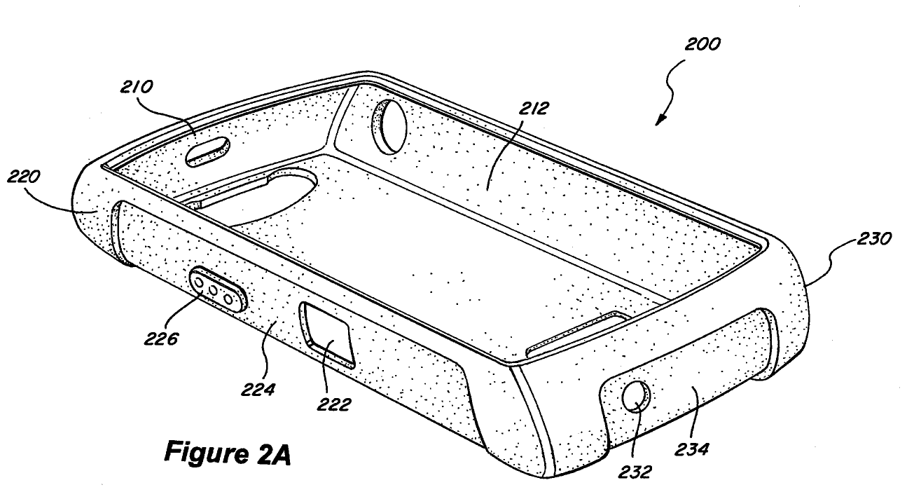

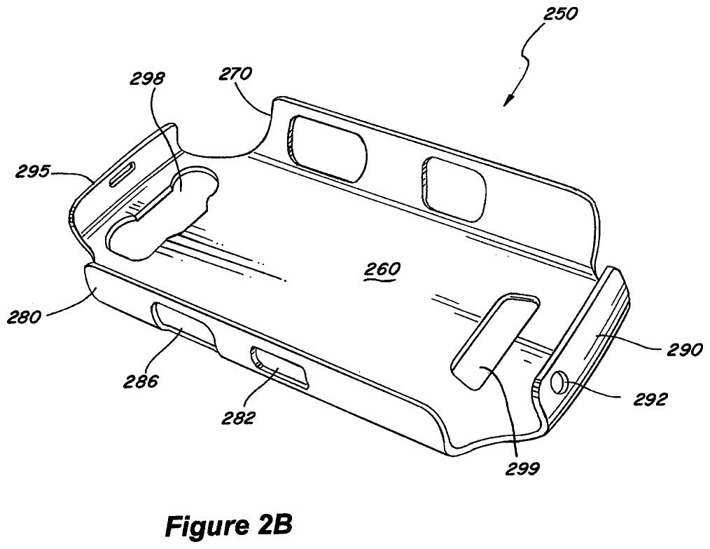

FIG. 4 is a perspective view of a mobile device enclosed in the flexible inner sleeve of FIG. 2A.

FIG. 5 is a perspective view of a mobile device enclosed in the flexible inner sleeve of FIG. 2A and the rigid shell of FIG. 2B.

FIG. 6 shows a mounting bracket for use with an embodiment of the disclosed protective case.

FIG. 7A is a top perspective view of an embodiment of the disclosed flexible inner sleeve.

FIG. 7B is a bottom plan view of the flexible inner sleeve of FIG. 3A.

FIG. 7C is a perspective inside view of an embodiment of a rigid shell for use with the flexible inner sleeve of FIGS. 7A and 7B.

FIG. 8 shows a mounting bracket for use with an embodiment of the disclosed protective case.

FIG. 9 shows a mounting bracket for use with an embodiment of the disclosed protective case.

FIGS. 10A-10F are front face, back face, left side, right side, top side, and bottom side views of a protective case for as mobile device with the mobile device received within the case.

FIG. 11A is a front face view of the protective case illustrated in FIGS. 10A-10F without the mobile device therein.

FIG. 11B is a bottom side view of the protective case illustrated in FIG. 11A.

FIGS. 11C-11D are front and back face perspective views, respectively, of the disassembled protective case illustrated in FIG. 11A showing the three component layers of the case. The perspective views are both taken from the left side.

FIG. 12 is a more detailed partial cross-sectional front face view taken along plane A-A of FIG. 11B showing in greater detail the construction of the case at the bottom end region including the corners and sides thereof and the relationship and configuration of the three integrated component layers.

FIG. 13 is a more detailed partial cross-sectional view of the protective case illustrated in FIG. 11A taken along crass-section line B-B showing in greater detail the construction of the case and the relationship and configuration of the three integrated component layers.

FIG. 14 is a more detailed cross-sectional view of the protective case illustrated in FIG. 11A taken along cross-section line C-C showing in greater detail the construction of the case and the relationship and configuration of the three integrated component layers.

FIG. 15 is a more detailed cross-sectional view of the protective case illustrated in FIG. 11A taken along cross-section line D-D showing in greater detail the construction of the case and the relationship and configuration of the three integrated component layers.

Each figure is generally to scale and hence relative dimensions of the various layers can be determined from the drawings.

### DETAILED DESCRIPTION OF THE ILLUSTRATED EMBODIMENTS

A protective case for a mobile device having a multi-layered construction is disclosed herein. The protective case is configured to receive, retain, and protect a mobile device. The protective case includes a front face and a hack face that define the height of the mobile device, a perimeter defined by top-end, bottom-end, right, and left sides residing between the front and back faces, and corners defined at the intersecting regions of the sides. The case may be for a mobile device that is in the film of a tablet, a mobile or smart phone, an MP3 audio player, a gaming device, or another portable handheld electronic device and may have one or more touchscreens, including on its front face and/or back face.

Protective Case with Two Layers

In some embodiments, the protective case has two layers. In such embodiments, the protective case includes a flexible inner sleeve liar conformingly surrounding the mobile device and a rigid shell for engaging the flexible inner sleeve.

In some embodiments, the flexible inner sleeve has a screen aperture and a plurality of indents, the screen aperture is configured such that the flexible inner sleeve cam receive the mobile device through the screen aperture, and the rigid shell has a plurality of fingers, where each finger engages a corresponding indent on the flexible inner sleeve.

In some embodiments, the flexible inner sleeve includes a screen aperture and at least one protrusion for manipulating a mobile device control or knob. The screen aperture is configured such that the flexible inner sleeve can receive the mobile device through the screen aperture. The flexible inner sleeve has a plurality of secondary apertures, where each secondary aperture is aligned with a respective mobile device connection port to allow connecting the mobile device to an auxiliary device. The rigid shell receives the flexible inner sleeve to thrill an integrated protective case. The rigid shell also includes a plurality of apertures which align with the secondary apertures of the inner sleeve. The inner sleeve or the rigid shell may be used independently to protect a mobile device, or alternatively, the inner sleeve and the rigid shell may be combined to provide an integrated protective unit for the mobile device.

In some embodiments, the protective case is a sleeve that includes a sheath having a backing and a plurality of edges. The sleeve has a face portion and a backing portion. The sleeve defines a first protrusion and a second protrusion which respectively correspond to a first control and a second control of the mobile device, where the sheath engagingly receives the sleeve between the plurality of edges, and where the sheath includes a first cavity and a second cavity for receiving the first protrusion and the second protrusion, respectively.

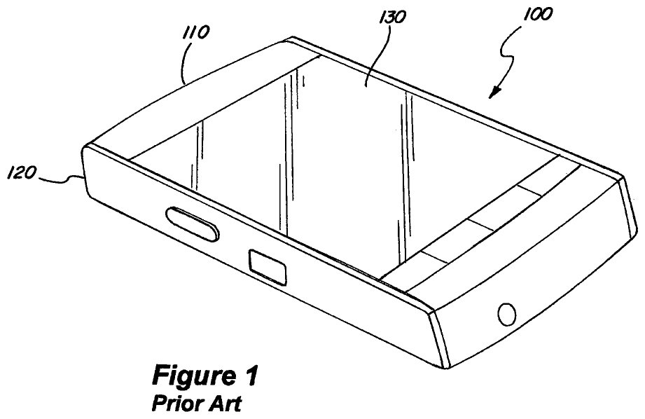

FIG. 1 is a perspective view of a conventional mobile device 100. Mobile device 100 may, for example, be a smartphone.

Mobile device 100 is shown with a top surface 110 and a side surface 120. Display 130 is conventionally integrated into the mobile device 100 and defines a screen which may, for example, be a touchscreen.

FIG. 2A is a perspective view of a flexible inner sleeve 200 for surrounding a mobile device 100. Flexible inner sleeve 200 may be molded to have the same shape and configuration as the mobile device it protects. Flexible inner sleeve 200 may be formed from a polymeric or rubber material with suitable elasticity. In some embodiments, the polymeric material includes silicon-based polymer and/or rubber material. Flexible inner sleeve 200 may also be formed from a foam-type elastic material. The elasticity of the flexible inner sleeve 200 provides several functionalities. First, the elastic polymer is soft to touch and provides excellent grip. Second, it protects against accidental dropping or other damage to the underlying mobile device, Finally, the elasticity enables the flexible inner sleeve 200 to be stretched Or slipped over the mobile device.

In FIG. 2A, the flexible inner sleeve 200 includes top surface 210 and side surfaces 220 and 230. Top surface 210 includes screen aperture or opening 212. In some embodiments, the screen aperture or opening 212 is large enough to provide unobstructed access to and view of the display screen of the mobile device. The screen aperture or opening 212 may be configured to be large enough to expose the entire mobile device screen but also small enough to cover the remaining portions of the mobile device. The top surface 210 forms an edge around the entire screen aperture or opening 212 to hold the mobile device within the flexible inner sleeve 200.

Side surface 220 includes side edge 224. Side edge 224 may be indented to releasably engage a rigid shell. In some embodiments, side edge 224 defines a mortise which may lockingly engage an edge of a rigid shelf in other embodiments, side edge 224 includes a groove for receiving and engaging a notch formed on the rigid shell. Side surface 220 also includes aperture 222 and protrusion 226. Aperture 222 may be formed on inner sleeve 200 to match and align with a port or an opening in the mobile device. The mobile device port typically defines a bus or a connection jack for connecting the mobile device to an auxiliary device.

Mortise 234 is formed on side surface 230 to engageably receive a rigid shell. In some embodiments, mortise 234 defines a depression or indent on the side surface 230 of inner sleeve 200. Aperture 232 is also formed on the side surface 230 of the inner sleeve 200 to align with a port or an opening in the mobile device. The port may be configured to receive, for example, a USB data connection or a headphone. The other sides (not shown) of inner sleeve 200 may have similar mortises, protrusions, and apertures formed thereon. Depending on the configuration of the underlying mobile device, mortises may be formed on all four sides of the inner sleeve 200 or on one, two, or three sides thereof. In some embodiments, where mortises are formed on two opposing sides of the flexible inner sleeve 200, the rigid shell can releasably engage two sides of the flexible inner sleeve 200. The limited elasticity of the rigid shell and the elasticity of the flexible inner sleeve 200 allow coupling of the flexible inner sleeve 200 to the rigid shell 250.

FIG. 2B is a perspective view of a rigid shell 250 for use with the flexible inner sleeve 200 of FIG. 2A. The rigid shell 250 includes a bottom surface 260 and side surfaces (interchangeably, side edges) 270, 280, 290, and 295. Side surfaces 270 and 280 engage opposing sides of the flexible inner sleeve 200 (see FIG. 2A). Similarly, side surfaces 290 and 295 engage opposing sides of the flexible inner sleeve 200. In this manner, the side surfaces function to secure the rigid shell 250 to the flexible inner sleeve 200. The side surfaces 270, 280, 290, and 295 of the rigid shell 250 may have corner openings at the four corners to expose the flexible inner sleeve 200.

Side surface 280 includes apertures 282 and 286 which correspond to aperture 222 and protrusion 226 of the flexible inner sleeve 200 (see also FIG. 2A). Aperture 286 receives protrusion 226, allowing the user to manipulate the underlying mobile device. Similarly, when the flexible inner sleeve 200 of FIG. 2A is engaged with the rigid shell 250 of FIG. 2B, the apertures 222 and 282 are aligned to provide access to a mobile device port (not shown). The alignment in the two apertures 222 and 282 allows the mobile device port to be exposed outside of the protective device and to be connected to an auxiliary device (e.g., a computer). In some embodiments, the apertures 222 and 282 align to form a cavity for a mobile device to protrude therefrom. Thus, the user can engage the dial without having to remove one or both of the protective devices.

Side surfaces 290 and 295 may be optionally added to grip opposing sides of the flexible inner sleeve 200. Side surface 290 includes an aperture 292 which aligns with aperture 232 of FIG. 2A. The apertures 232 and 292 may be used or a camera lens in the mobile device. When the flexible inner sleeve 200 of FIG. 2A is aligned with the rigid shell 250 of FIG. 2B, the apertures 232 and 292 provide access to the mobile device port. The hard shell 250 and the flexible inner sleeve 200 may be configured to follow the contours of the underlying mobile device. In some embodiments, the flexible inner sleeve 200 follows the contours of the mobile device and the bard shell 250 follows the contours of the flexible inner sleeve 200. When assembled, the two-part protection system (i.e., the hard shell and the flexible inner sleeve) does not add substantially to the overall size and weight of the device.

Aperture 298 may be optionally added to receive a bracket for connecting rigid shell 250 to an outside mount. Aperture 298 may be replaced by a clip or any other suitable mounting apparatus which allows attaching the mobile device to a belt or pockets. While not shown, the flexible inner sleeve may also include similar configurations for attaching directly to clothing. Aperture 299 may be used to mate with a corresponding protrusion on flexible inner sleeve 200 to allow for better securement and releasing of the two parts.

While FIGS. 2A and 2B show four surfaces for engaging hard shell 250 to flexible inner sleeve 200, other configurations are also possible. In some embodiments, the hard shell 250 may be configured to engage the flexible inner sleeve 200 at two or more of its sides or corners. In other embodiments, the hard shell 250 may be configured to engage the flexible inner sleeve 200 at only two edges. In still other embodiments, the hard shell may be designed to slidingly receive the flexible inner sleeve by forming a tongue-and-groove feature with the inner sleeve. In yet other embodiments, the flexible inner sleeve may be snapped into place using one or more coupling points with the rigid shell.

FIG. 3A is a perspective view of a prior art flexible inner sleeve 300 for surrounding a mobile device 312. The flexible inner sleeve 300 is designed to conform to the contours of the mobile device 312 (e.g., an iPhone™). The mobile device 312 includes display and keyboard sections on the face thereof The flexible inner sleeve 300 is made of a soft-touch silicon lining to protect the mobile device 312 from shocks or other static electricity. The flexible inner sleeve 300 includes apertures 310 and 322. Aperture 310 receives the mobile device 312. Aperture 322 provides an opening for accessing a mobile device port. Protrusion 326 is positioned over a mobile device control, such as a volume control. Protrusion 326 allows the user to effect a change in the mobile device by pressing the protrusion. The change may be, for example, increasing or decreasing the volume of the mobile device. Protrusion 326 has two parts, corresponding to the volume increase and decrease buttons of the mobile device, The flexible inner sleeve 300 includes four indents 331, 332, 333, and 334 at its four corners. The four indents 331, 332, 333, and 334 mate with the four fingers 351, 352, 353, and 354, respectively, on the hard shell 350 to protect the four corners from accidental dropping of the mobile device 312.

FIG. 3B is a bottom plan view of the flexible inner sleeve 300 of FIG. 3A. The flexible inner sleeve 300 includes a bottom surface 301 that mates with an inner surface 302 of a rigid shell 350 (see also FIG. 3C). Four outer convex raised portions 341, 342, 343, and 344 surround the bottom surface 301. The outer convex raised portions 342 and 344 allow the user to grab the soft flexible inner sleeve 300 While still providing the hard protection of the rigid shell 350. The flexible inner sleeve 300 includes a center raised portion 345 to snugly mate with an opening 370 on the rigid shell 350 to provide a better connection between the flexible inner sleeve 300 and the rigid shell 350.

FIG. 3C is a perspective view of a prior art rigid shell 350 for use with the flexible inner sleeve 300 of FIGS. 3A and 3B. The rigid shell 350 is a hard or rigid acrylic shell that engages the mobile device 312 through the flexible inner sleeve 300. The rigid shell 350 includes four fingers 351, 352, 353, and 354 to grab, attach to, or fit into the four indents 331, 332, 333, and 334 of the flexible inner sleeve 300 of FIGS. 3A and 3B. The four fingers 351, 352, 353, and 354 provide protection to the four corners of the mobile device. The rigid shell 350 also has four concave sides 361, 362, 363, and 364 to snugly fit against the corresponding outer convex raised portions 341, 342, 343, and 344, respectively, when attached to the flexible inner sleeve 300. The rigid shell 350 does not cover the sides (i.e., the four outer convex raised portions 341, 342, 343, and 344) but does cover the bottom surface 301 of the flexible inner sleeve 300. Exposing the four outer convex raised portions 341, 342, 343, and 344 of the flexible inner sleeve 300 allows the user to have a better grip while still providing the rigid shell 350 to protect the mobile device 312.

FIG. 4 is a perspective view of a mobile device 100 enclosed in the flexible inner sleeve 200 of FIG. 2A. In FIG. 4, the mobile device 100 is inserted inside the flexible inner sleeve 200 through the screen aperture 212. Protrusion 226 aligns with a control knob (not shown) of the mobile device 100 and the aperture 222 provides an opening to access a mobile device port 414. Screen 416 of the mobile device 100 is readily accessible to a user.

FIG. 5 is a perspective view of a mobile device 100 enclosed in the flexible inner sleeve 200 of FIG. 2A and the rigid shell 250 of FIG. 2B. Specifically, FIG. 5 shows the flexible inner sleeve 200 containing the mobile device 100. The combination of the flexible inner sleeve 200 and the rigid shell 250 protect the mobile device 100 while allowing immediate access to the buttons and screen of the mobile device 100. The flexible inner sleeve 200 is snugly fit around the mobile device 100 and the rigid shell 250 is snapped or attached to the flexible inner sleeve 200. The combination of the rigid shell 250 and the flexible inner sleeve 200 may be coupled to the user through a clip (not shown).

FIG. 6 shows a prior art mounting bracket 600. The mounting bracket 600 has a curved portion 650 for receiving the mobile device 100.

FIG. 7A is a top perspective view of a flexible inner sleeve 700 for surrounding a mobile device 712. The flexible inner sleeve 700 is designed to conform to the contours of the mobile device 712 (e.g., an iPhone™). The mobile device 712 includes display and keyboard sections on the face thereof. The flexible inner sleeve 700 may be made of a soft touch silicon rubber lining to protect the mobile device 712 from shocks or other static electricity. The flexible inner sleeve 700 includes aperture's 710 and 722. Aperture 710 receives the mobile device 712. Aperture 722 provides an opening for accessing a mobile device port. Protrusion 726 is positioned over a mobile device control, such as volume control. Protrusion 726 allows the user to effect a change in the mobile device 712 by pressing the protrusion 726. The change may be, for example, increasing or decreasing the volume of the mobile device 712. In some embodiments, protrusion 726 is configured to have two parts corresponding to volume increase and decrease buttons of the mobile device. The flexible inner sleeve 700 includes four indents 731, 732, 733, and 734 at its four corners. The four indents 731, 732, 733 and 734 mate with the four fingers 751, 752, 753, and 754, respectively, on the hard shell 750 to protect the four corners of the mobile device 712 from accidental dropping of the mobile device 712.

FIG. 7B is a bottom plan view of the flexible inner sleeve 700 of FIG. 7A. The flexible inner sleeve 700 includes a bottom surface 701 that mates with an inner surface 702 of as rigid shell 750 (see also FIG. 7C). Four outer raised portions 741, 742, 743, and 744 surround the bottom surface 701. The outer raised portions 742 and 744 allow a user to grab the soft flexible inner sleeve 700 while still providing the hard protection of the rigid shell 750.

FIG. 7C is a perspective view of a rigid shell 750 for use with the flexible inner sleeve 700 of FIGS. 7 A and 7B. The rigid shell 750 may be a hard or rigid acrylic shell configured to engage the mobile device 712 directly or through the flexible sleeve 700. The rigid shell 750 includes four fingers 751, 752, 753, and 754 to grab, attach to, or fit into the four indents 731, 732, 733, and 734 of the flexible inner sleeve 700 of FIGS. 7A and 78. The four fingers 751, 752, 753, and 754 provide protection to the four corners of the mobile device. The rigid shell 750 also has four sides 761, 762, 763, and 764 to snugly fit against the corresponding outer raised portions 741, 742, 743, and 744, respectively, when attached to the flexible inner sleeve 700. In some embodiments, the rigid shell 750 does not cover the sides (i.e., the four outer convex raised portions 741, 742, 743, and 744) but does cover the bottom surface 701 of the flexible inner sleeve 700. Exposing the four outer raised portions 741, 742, 743, and 744 of the flexible inner sleeve 700 allows the user to have a better grip while still providing the rigid shell 750 to protect the mobile device 712.

FIG. 8 shows a mounting bracket 800 for use with an exemplary protective case. The mounting bracket 800 is formed in the shape of a “Z” and may have a curved portion 815 for receiving the mobile device 100. The mounting bracket 800 has a similar curved portion 805 on the other side. In some embodiments, the mounting bracket 800 has an opening 810 positioned between the two curved portions 805 and 815.

FIG. 9 shows a mounting bracket 900 for use with an exemplary protective case. The mounting bracket 900 is formed in the shape of an “S” and may have a curved portion 915 for receiving the mobile device 100. The mounting bracket 900 has a similar curved portion 905 on the other side.

Protective Case with Three Layers

In some alternate embodiments, the case may be formed of a multilayered construction that includes three layers, various aspects of which are described below. The first layer is defined by inner and outer surfaces and dimensioned to cover a portion of the back thee of the mobile device and/or extend around a portion of the perimeter of the mobile device at the back face boundary. The inner surface of the first layer includes a plurality of protrusions that extend in a direction generally away from the outer surface.

The second layer is defined by inner and outer surfaces and is also dimensioned to cover a portion of the back face of the mobile device and extend around a portion of the perimeter of the mobile device at the back face boundary. The second layer may further include a plurality of corner protrusions positioned along the perimeter region of the second layer to correspond in location with the corners of the mobile device. The second layer may further include an elevated pattern of interconnected walls extending from its inner surface a height above and in a direction away or opposite from the second layer's outer surface. The second layer further includes a plurality of apertures extending into its outer surface that surround (e.g., in close and firm proximity or contact with) one or more of the protrusions of a first group of protrusions of the first layer. The second and/or first layers may each be configured to cover the entire, a majority, half, or less than half of the back face of the mobile device and may be configured to extend around the entire, a majority, half, or less than half of the perimeter of the mobile device at the back face boundary.

The third layer is similarly defined by third inner and outer surfaces and is dimensioned to cover a portion of the top-end, bottom-end, right, and/or left sides of the mobile device. The third layer may include one or more indentations in its inner surface at the corners. The indentations may be in the reverse image of, or otherwise dimensioned to receive, one or more of the corner protrusions of the second layer. The third layer may also include control apertures that are dimensioned and positioned to allow access to control buttons or ports on the mobile device.

The first, second, and third layers may be co-molded to form an integrated construction. The first layer may be made of a first material that has a first hardness, the second layer may be made of a second material that has a second hardness, and the third layer may be made of a third material that has a third hardness. The first hardness is greater than the third hardness, and the third hardness is greater than the second hardness.

For example, the first layer may have a Shore A durometer hardness that is 40% or more greater than the third layer, 30% or more greater than the third layer, 20% or more greater than the third layer, or 10% or more greater than the third layer all ±5% as measured using the American Society for Testing and Materials (ASTM) standard D2240. The second layer may have a Shore A durometer hardness of 45±10, 45±5, or 45 as measured using the American Society for Testing and Materials (ASTM) standard D2240. The third layer may have a Shore A durometer hardness of 65±10, 65±5, or 65 as measured using the American Society for Testing and Materials (ASTM) standard D2240. The third layer may also, for example, have a Shore A durometer hardness that is 40% or more greater than the second layer, 30% or more greater than the second layer, 20% or more greater than the second layer, or 10% or more greater than the second layer all ±5% as measured using the American Society for Testing and Materials (ASTM) standard D2240.

The first, second, and third layers may be formed of a composition comprised of one or more materials including but not limited to polycarbonate (PC), thermoplastic urethane (TPU), thermoplastic elastomer (TPE), acrylonitrile butadiene styrene (ABS), nylon, metal, silicone rubber, or any combination thereof. For example, the first layer, which is the hardest of the three layers, may be formed of a composition comprised of polycarbonate, a combination of polycarbonate and ABS, nylon, fiber-reinforced plastic, and/or metal. The second layer, which is the softest of the three layers, may be formed for example of a composition comprised of TPE, silicone rubber, or combination thereof or other suitable materials. The third layer, which has a hardness between the hardness the other two layers, may be formed for example of a composition that has a relatively high resistance to scratching such as a composition comprised of TPU and/or TPE or a combination thereof or another suitable material.

Thus, in use, when there is an impact at the corners, the third layer, which has a high resistance to scratching and a higher hardness than the second layer, distributes the force of impact and, to the extent the energy of the force is transferred to the second layer, the second layer dampens the shock, especially at the impact prone corners, to thereby mitigate the transfer of the impact energy to the device.

One or more of the plurality of protrusions of the first layer may have a first external shape selected from a group consisting of a square, an octagon, a pentagon, a rectangle, a triangle, a circle, a hexagon, and a heptagon. Also, one or more of the plurality of protrusions may include an aperture residing within the protrusion that defines a first shape selected from a group consisting of: a square, an octagon, a pentagon, a rectangle, a triangle, a circle, a hexagon, and a heptagon. Also, the plurality of protrusions in the first layer may be dimensioned to be below, above, or flush with the height of the wails of the second layer that surround the protrusions. Thus, some of the plurality of protrusions in the first layer may be dimensioned to be flush with the height of the interconnected walls in the second layer adjacent thereto, some of the plurality of protrusions may be dimensioned to be below the height of the interconnected walls adjacent thereto, and some of the plurality of protrusions may be dimensioned to be above the height of the interconnected walls adjacent thereto. The plurality of protrusions may be comprised of multiple groups of protrusions with each protrusion in each group being equally or unequally spaced from one another or spaced in a defined pattern. The plurality of protrusions may be comprised of a first group configured to reside closer to the top end or side than the bottom end or side, a second group may be configured to reside closer to the bottom end or side than the top end or side, and a third group may be configured to reside an equal distance from the right and left sides.

The number of corner protrusions in the second layer may be two, three, four, or more (depending on the number of corners on the mobile device), each of which is configured to reside at one, some, or all of the corners of the mobile device or any combination of corners thereof. For example, one corner protrusion may be configured to reside at a corner defined in part by the top side of the mobile device and another corner protrusion may be configured to reside at a corner defined in part by the bottom side. By way of another example, one corner protrusion may be configured to reside at a corner defined in part by the right side of the mobile device and another corner protrusion may be configured to reside at a corner defined in part by the left side of the mobile device. By way of yet another example, a first corner protrusion may be configured to reside at a corner defined in part by the top side of the mobile device (e.g., the intersection between the top side and the right or left side), a second corner protrusion may be configured to reside at a corner defined in part by the bottom side (e.g., the intersection between the bottom side and the right or left side), a third corner protrusion may be configured to reside at a corner defined in part by the right side (e.g., the intersection between the right side and the top or bottom side), and a fourth corner protrusion may be configured to reside at a corner defined in part by the left side (e.g., the intersection between the left side and the top or bottom side). Correspondingly dimensioned corner indentations in the inner surface of the third layer may be provided to engagingly surround or receive one, some, or all of the corner protrusions. Thus, some or all of the surfaces that define the indentions on the third layer may be in contact with a corresponding Corner protrusion on the second layer.

The corner protrusions may be configured or dimensioned to reside above, below, or flush with the height of the mobile device in any combination. For example, one of the corner protrusions may be configured to extend above the height of the mobile device and another of the corner protrusions may be configured to be flush with the height of the mobile device. Alternatively, all of the corner protrusions may be configured to be flush with the height of the mobile device or may be configured to reside below the height of the mobile device. One or all of the corner protrusions may also have uniform or varying dimensions in width and thickness between the base and the apex of the protrusion. For example, the corner protrusions may include a thickness defined between the inner and outer surfaces that varies with the height of the protrusion, such as being thicker (or thinner) at the base of the corner protrusion as compared to the thickness closer to the apex of the corner protrusion. By way of another example, the width generally perpendicular to the thickness may be wider (or narrower) at the base of the corner protrusion as compared to width near the apex of the corner protrusion.

The pattern of elevated interconnected walls of the second layer may be comprised of any arrangement of shapes selected for example from a group consisting of squares, octagons, pentagons, rectangles, triangles, circles, hexagons, heptagons, or in combination thereof. By way of example, the interconnected walls may be comprised of walls that form hexagons or portions thereof, which together create a honeycomb wall pattern. The apertures in the second layer and the plurality of protrusions of the first layer may also be hexagonal in shape and dimensioned to closely or snugly fit or mate together, so that one, some, or all six of the walls that form the mating hexagons are in contact with one another. The pattern of elevated interconnected walls may be contiguous or dis-contiguous, may or may not extend to the perimeter regions of the second layer, may be positioned in discrete regions, or may be spaced apart from one another. Various patterns comprising one or more shapes may be employed alone or in combination with other patterns, such that one region of the inner surface of the second layer may have one pattern and another region of the inner surface of the second layer may have another pattern. The elevated pattern of interconnected walls may be configured in height and construction so as to suspend the back face of the mobile device above the apertures defined by the interconnected wails so that the back face of the mobile device does not bottom-out on (or become in contact with) the recessed inner surface of the second layer. Although not depicted, a pattern of interconnected walls may also be employed on the inner surface of the third layer to create an air-suspension frame around the mobile device at the perimeter and front face regions of the mobile device as well as the one created by the second layer vis-a-vis the bark face region.

The second layer may further comprise one or more button protrusions that are dimensioned and configured to extend within one or more of the control apertures of the third layer. Each button protrusion may or may not be co-molded to the perimeter of the control aperture to form an integrated region therewith and may be configured to reside above or over a user control button on the mobile device such as a volume, power, mute, or other user button.

The third layer may also include one or more stability tabs configured to extend underneath the back face of the mobile device. The inner surface of the tab may be in contact with the outer surface of the second layer, while the outer surface of the tab may be exposed externally. The tab may be received within an aperture on the first layer that opens to the perimeter. The aperture may be configured to reside closer to one end of the mobile device than the other end and may be configured to reside closer to one side of the mobile device than the other side. Alternatively the aperture and tab may be configured to be centrally positioned relative to one or more sides of the mobile device.

The third layer may also be configured to include a retention rim positioned to reside over the perimeter region of the front thee of the mobile device to retain the mobile device within the case. The retention rim may encircle a portion or the entire front face. For example the retention rim may be configured to extend along the top, bottom, left, or right sides of the mobile device or any combination thereof. For example, the rim may extend only in the corner regions or only in regions other than the corner regions, or in a combination of corner and non-corner regions, which may facilitate insertion and removal of the mobile device from the phone. In this respect, the case is configured and constructed with sufficient flexibility to allow the user to install and remove the mobile device, within the case without damaging the case or the mobile device.

The third layer may further comprise one or more button protrusions. Each button protrusion may be configured to reside above or over a user control button on the mobile device such as a volume, power, mute, or other user button. In embodiments where the third layer comprises one or more button protrusions, the second layer preferably will not include button protrusions.

The second layer may include one or more apertures to allow for functionality and so as to facilitate the intended use of the mobile device. For example, the second layer may include a camera lens aperture that extends therethrough and is configured to reside around the outside of a camera lens window on the hack face of the mobile device. The walls that define the apertures, may extend through the first layer and may overlap the outer surface of the third layer. To the extent there is a touchscreen on the back face or other surface region of the mobile device, the second and first layers may have an aperture to allow user interaction with that touchscreen.

Methods of manufacturing a protective case that includes one or more of the various foregoing aspects are also disclosed. Manufacturing steps may, for example, include:
(1) co-molding three distinct layers within a mold to form an integrated protective case construct;
(2) molding the first layer defined by first inner and outer surfaces and dimensioned to cover at least a portion of the back face of the mobile device and extend around at least a portion of the perimeter of the mobile device at the back face boundary; where the first layer may be molded to include a first plurality of protrusions extending from its inner surface in a direction away from its outer surface; and where the first layer may be molded of a material that is harder than each of the second and third layers;
(3) co-molding, around the perimeter regions of the first layer, the third layer defined by third inner and outer surfaces and dimensioned to cover one or more regions of the top, bottom, right, and left sides of the mobile device; where the third layer may be further molded to include one or more control apertures dimensioned and positioned to allow access to control buttons or ports on the mobile device; and include indentations in its inner surface at regions configured to reside at the corners of the mobile device, where the indentations are dimensioned to surround corner protrusions of the second layer; and where the third layer may be molded of material that is harder than the second layer; and
(4) co-molding onto the inner surface of both the first and third layers, the second layer defined by second inner and outer surfaces and dimensioned to cover at least a portion of the back face of the mobile device and extend around at least a portion of the perimeter of the mobile device at the back face boundary; where the second layer may include a plurality of corner protrusions positioned along the perimeter region of the second layer to correspond in location with corners of the mobile device and dimensioned to extend at, below, or above the height of the mobile device (as measured thereat between the front and back faces); may include a pattern of walls extending from its inner surface a height above and to a direction away from its outer surface that may form any arrangement of shapes selected for example from a group consisting of squares, octagons, pentagons, rectangles, triangles, circles, hexagons, heptagons, or any combination thereof; and may include a plurality of apertures that surround and are in contact with one or more of the protrusions in the first layer.

Commonly disclosed in FIGS. 10-15 is a protective enclosure or case 2200 for a mobile device 2100 that illustrates, by way of example, various configuration and construction aspects of the case. In this particular embodiment, the case is configured for an Apple iPhone 5s™ mobile or smartphone device. It should be understood, however, that the case may be configured for any mobile device or electronic device, including but not limited to portable or cellular phones, PDAs, gaming devices, laptop computers, or tablet devices.

As best depicted in FIGS. 10A-10F, the mobile device 2100 includes front 2110 and back 2120 faces, and a left side 2130, a right side 2140 (hidden from view), a top side 2150, and a bottom side 2160 that together define the perimeter 2170 of the mobile device 2100. The front and back faces are flat and the sides have flat surfaces that extend between the front 2110 and back 2120 faces and the distance between the front 2110 and back 2120 faces define the height of the device 2100. Corner regions 2180 are defined at the curved regions where the sides intersect with one another. The front face 2110 includes a touchscreen 2112 user interface, a home button 2114 with biometric sensor (surrounding the home button), speakers, a front facing camera, and proximity sensors 2116, 2117, and 2118 (located at the top end region on the front face of the phone) that are not shown in the illustrations, but well known to one of ordinary skill in the art. The back face 2120 includes a camera lens window 2122, a flash 2124, and a microphone 2125 that are grouped together in the upper corner on the right side of the device 2100. The left side 2130 includes volume control buttons 2132 (hidden below the corresponding case + and − buttons) and ringer silent switch 2134 that controls whether the phone is on silent mode. The top side 2150 includes a depressible power button 2152 (also hidden behind the corresponding power button 2254 on the case). The bottom side 2160 includes a headphone jack 2162, microphone grill 2164, and a data and charging port 2166.

Generally, the protective case 2200 includes front 2210 and back 2220 face walls and left side 2230 and right side 2240 walls and top side 2250 and bottom side 2260 walls. The side walls, 2230, 2240, 2250, and 2260 reside between the front and back faces. Each of the walls 2210, 2220, 2230, 2240, 2250, and 2260 are dimensioned to correspond in dimension to the front and back faces, and left, right, top, and bottom sides 2110, 2120, 2130, 2140, 2150, and 2160 of the mobile device 2100, respectively.

More specifically, the front face wall 2210 is defined by inner 2211 and outer 2212 surfaces and includes an inwardly projecting rim 2214 (best illustrated in the cross-sectional views of FIGS. 14 and 15). The back face wall 2220 is also defined by inner 2221 and outer 2222 surfaces and includes a camera lens and flash opening or aperture 2224 extending therethrough.

The left side 2230 and right side 2240 walls are also each defined by inner and outer surfaces 2231 and 2232 and 2241 and 2242, respectively. The left side wall 2230 further includes volume control buttons 2234 that are positioned, dimensioned, configured, and adapted to interface and actuate the volume control buttons 2132 on the mobile device 2100. Also included in the left side wall 2230 is an opening or aperture 2236 that is positioned and dimensioned to correspond with the ringer silent switch 2134 of the mobile device 2100 to provide functional user access to the switch 2134. The right side wall 2240 does not include any apertures or control buttons as none are provided on the Apple iPhone 5s™ mobile device for which the illustrated case is configured to protect. However, the right side wall may, in alternate embodiments, include either apertures and/or buttons to provide access to or control over corresponding ports or buttons on the mobile device in embodiments where the device has controls or ports on that side. It should be understood, however, that the number of apertures may vary (increase or decrease) and their placement may vary to correspond with controls on the mobile device.

The top side 2250 and bottom side 2260 walls are also each defined by inner and outer surfaces 2251 and 2252 and 2261 and 2262 respectively. The top side wall 2250 includes a mobile device power button 2254 positioned, dimensioned, configured, and adapted to interface with the power button 2152 on the mobile device 2100. In the embodiment illustrated, the button 2254 resides within an aperture 2255 and is connected thereto. For example, the button 2254 may be connected in a levered manner 2256 to top side wall 2250 at one end or at a mid-section of the aperture 2255, such that when pressed, the button 2254 hinges around the lever connection. The bottom side wall 2260 includes perforated regions 2264 positioned and dimensioned to correspond with the microphone grill 2164 regions on mobile device 2100. The bottom side wall further includes a headphone jack 2266 and data/charge port apertures 2267 that are positioned and dimensioned to correspond with the headphone jack port 2162 and the data and charging port 2166, respectively. Collectively the side walls 2230, 2240, 2250, and 2260 define perimeter 2270 between the front and back faces 2210 and 2220 of the protective case 2200.

The case 2200 is formed multilayered construction that includes three layers 2300, 2400, and 2500 that are co-molded, together to a unitary integral construct. Various aspects of these layers and their inter-relationship, construction, and manufacture are described in detail below.

As best illustrated in FIGS. 11C-11D, the first layer 2300 is defined by first inner 2310 and outer 2311 surfaces, and is dimensioned to cover the back face 2120 of the mobile device 2100. The first layer 2300 is configured to extend to the perimeter 2170 of the mobile device 2100 at the back face 2120 boundary, which is the perimeter defined by the intersection of the side walls 2130, 2140, 2150, and 2160 and the back face 2120 of the mobile device 2100. The first inner surface 2310 includes a first plurality of protrusions 2320 (best illustrated in FIGS. 11A and 11C) extending generally in a direction away from the outer surface 2311 or the first layer 2300.

The second layer 2400 is defined by second inner 2410 and outer 2411 surfaces, and is also dimensioned to cover the back face 2120 of the mobile device and extend around the perimeter 2170 of the mobile device 2100 at the back face 2120 boundary. The second layer 2400 further includes a plurality of corner protrusions 2420 positioned along the perimeter region of second layer 1400 to correspond in location with the corners 2180 of the mobile device 2100. The corner protrusions 2420 are dimensioned to reside at a height that is slightly below the height of the mobile device 2100 at the corners 2180. However, its alternate embodiments, one, some, or all of the corner protrusions 2420 may extend at, below, or above the height of the mobile device 2100 in any combination. The second layer 2400 may further include an elevated pattern of interconnected walls 2430 extending from the second inner surface 2410 a height above and in a direction away from the second outer surface 2411. Also included in the second layer 2400 is a plurality of apertures 2440 extending into second outer surface 2411, such that one or more of the apertures 2440 are dimensioned and positioned to surround (e.g., in close proximity and firm contact) one or more of the protrusions 2320 of first layer 2300.

The first 2300 and second 2400 layers ma be configured to cover the entire, a majority, half, or less than half of the back face 2120 of the mobile device 2100 and may be configured to extend to or around the entire, a majority, half, or less than half of the perimeter 2170 of the mobile device 2100 at the back face 2120 boundary.

In the illustrated embodiment, the first layer 2300 is configured to cover nearly the entire back face 2120 of the mobile device 2100, with the exception of the flash and camera lens window aperture 2224 and nearly the entire perimeter 2170 of the back face 2120 with the exception of the tab aperture 2350, described in more detail below. It should be understood however, that alternative configurations may be employed. For example, interposed or intervening regions, such as those between the protrusions 2320 and/or apertures 2440, may be removed from the first 2300 and/or second 2400 layers while perimeter regions of the first 2300 and/or second 2400 layers may be maintained. Perimeter regions in the first 2300 and/or second 2400 layers that reside between one or more of the corners may be removed. Mid-section regions of the layers 2300 and 2400 may be removed to allow for access to, or user utilization of, user controls, additional touchscreen interface, and/or other device features (e.g., speakers, cameras, lights, microphone, etc.) that are located on the side walls 2130, 2140, 2150, and 2160 and/or back face 2120 of the mobile device 2100.

Additionally, while the pattern of walls 2430 in the second layer 2400 is illustrated as being interconnected and elevated, it should be understood that the walls may be disconnected at one or more locations or in discrete regions. Also, while the pattern of walls 2430 are illustrated as having a generally uniform height or elevation, it should be understood that the walls 7430 may have differing heights at discrete regions within the pattern or within or at specific walls or wall segments within the pattern of walls 2430.

The third layer 2500 is also defined by third inner 2510 and outer 2511 surfaces. The third layer 2500 is generally dimensioned to cover the left 2130, right 2140, top 2150 and/or bottom 2160 sides of the mobile device 2100 and forms the inwardly projecting rim 2214 of the front face wall 2210. While in the illustrated embodiment the third layer 2500 extends around the entire perimeter of the mobile device 2100, it may be configured in other ways. Thus it should be understood that the third layer 2500 may cover the entire, a majority, half, or less than half of the top, bottom, right and/or left sides of the mobile device 2100 and/or may be configured to extend around less than the entire, a majority, half, or less than half of the perimeter 2170 of the mobile device 2100 in any combination. Thus, for example the third layer may cover the corners of the mobile device alone or may cover the corners of the mobile device with and only a portion of one or more of the sides extending therebetween. The third layer 2500 includes one or more mobile device 2100 control apertures 2530 that extend through the layer that are dimensioned and positioned to allow access (or flow through with respect to speakers and the like) to control buttons or ports (e.g., power button 2152, volume button 2132, ringer silent switch 2134, headphone jack 2162, microphone grill 2164, and data/charging port 2166) on the mobile device 2100. However, it should be understood that, in alternate embodiments, the third layer may instead include button protrusions in place of one or more of the apertures. The third layer also further includes one or more indentations 2540 in the third inner surface 2510 at regions configured to reside at the corners 2180 of the mobile device 2100. The indentations 2540 are configured to be in the negative image of the corner protrusions or otherwise dimensioned to receive one or more of the plurality of corner protrusions 2420 of the second layer 2400.

While, the first 2300, second 2400, and third 2500 layers may be co-molded to form an integrated construction, it should be understood that it is contemplated that only portions of one or more of the layers may be co-molded, or each of the layers may be separately formed and mechanically attached to one another by clips, snaps, or latches between each of the components or between, for example, the third layer and the first layer. A combination of co-molding and mechanical attachment of the layers or portions thereof may also be employed. In a fully integrated or co-molded construction the case 2200 would be properly dimensioned and have sufficient flexibility to allow the user to insert and remove the mobile device 2100 without damage to the case 2200. When the components are modular or separable from one another, the user may wrap the second layer around the mobile device 2100 and then clip the first and third layers in position around the device 2100. The clips, snaps, or hooks or other mechanical, attachments may be formed or molded into: (a) two or more of the layers at their perimeter regions, (b) the protrusions 2320 and apertures 2440 of the first 2300 and second 2400 layers, (c) one or more of the corner protrusions 2420 and indentations 2540 in the second 2400 and third 2500 layers, (d) the control buttons 2234 and corresponding apertures 2530 on the second 2400 and third 2500 layers, and/or (e) at any region where two or more layers are in contact or proximity to one another. Thus, a combination of co-molding and/or mechanical attachment of the layers may be employed. Alternatively or in addition, one or more of the layers may be adhesively attached or otherwise bonded to one another.

The materials that form the layers may be selected based on their hardness. For example, the first layer 2300 may be made of a first material that has a first hardness, the second layer 2400 may be made of a second material that has a second hardness that is different from the first layer, and the third layer 2500 may be made of a third material that has a third hardness that is different from the first or second hardness. In a preferred embodiment, the first hardness is greater than the third hardness and the third hardness is greater than the second hardness.

In the illustrated embodiment the protrusions 2320 have a hexagonal external and internal shape. However, it should be understood that other shapes may be employed. For example, one or more or all of the plurality of protrusions 2320 of the first layer 2300 may have a first external shape selected from a group consisting of a square, an octagon, a pentagon, a rectangle, a triangle, a circle, a hexagon, and a heptagon. One or more or all of the plurality of protrusions 2320 may each include an aperture 2321 residing therein that defines an internal shape selected from a group consisting of a square, an octagon, a pentagon, a rectangle, a triangle, a circle, a hexagon, and a heptagon. One or more or all of the plurality of protrusions 2320 may be dimensioned so that the upper surface 2322 is below, above, or flush with the upper surface 2422 height of the interconnected walls 2430 of the second layer 2400 surrounding the protrusions 2320 of the first layer 2300. Thus, some or none of the plurality of protrusions 2320 may be dimensioned to be flush with the height of the interconnected walls 2430 adjacent thereto (as shown in the drawings), some or none of the plurality of protrusions 2320 may be dimensioned to be below the height of the interconnected walls 2430 adjacent thereto, or some or none of the plurality of protrusions 2320 may be dimensioned to be above the height of the interconnected walls 2430 adjacent thereto. The plurality of protrusions 2320 may be comprised of multiple groups of protrusions with each protrusion 2320 in each group being equally spaced from one another.

The plurality of protrusions may be comprised of as first group configured to reside closer to the top end side 2250 than the bottom end side 2260, a second group may be configured to reside closer to the bottom end side 2260 than the top-end side 2250, and a third group may be configured to reside an equal distance from the right 2240 and left 2230 sides. One or more protrusions may be positioned in each corner region, the mid region and/or closer to the perimeter than the middle of the case.

The number of corner protrusions 2420 in the second layer 2400 may be selected from a group consisting of two, three, and four (or more if mobile device has more than four) configured to reside at one, some, or all of the corners 2180 of the mobile device 2100 or any combination of corners thereof. For example, one corner protrusion 2420 may be configured to reside at a corner 2180 defined in part by the top side 2150 of the mobile device 2100 and another corner protrusion 2420 may be configured to reside at a corner defined in part by the bottom side 2160. By way of another example, one corner protrusion 2420 may be configured to reside at a corner 2180 defined in pant by the right side 2140 of the mobile device 2100 and another corner protrusion 2420 may be configured to reside at a corner 2180 defined in part by the left side 2130 of the mobile device 2100. By way of yet another example, a first corner protrusion 2420 may be configured to reside at a corner 2180 defined in part by the top side 2150 of the mobile device 2100, a second corner protrusion 2420 may be configured to reside at a corner 2180 defined in part by the bottom side 2160, a third corner protrusion 2420 may be configured to reside at a corner 2180 defined in part by the right side 2140, and a fourth corner protrusion 2420 may be configured to reside at a corner 2180 defined in part by the left side 2130. Corresponding dimensioned corner indentations 2540 in the third layer 2500 may be provided to engagingly receive one, some, or all of the corner protrusions 2420. Thus, some or all of the surfaces that define the indentions on the third layer may he in contact with corresponding surface is of the corner protrusions 2420 on the second layer 2400. In this respect, the corner indentations 2540 may be configured to have a reverse image of the desired shape of the corner protrusions 2420.

The corner protrusions 2420 may be configured or otherwise dimensioned to reside above, below, or flush with the height of the mobile device 2100, in any combination. For example, one of the corner protrusions 2420 may be configured to extend above the height of the mobile device 2100 and another of the corner protrusions 2420 may be configured to be flush with the height of the mobile device 2100. Alternatively, all of the corner protrusions 2420 may be configured to be flush with the height of the mobile device 2100 or may be configured to reside below or above the height of the mobile device 2100. The corner protrusions 2420 may also have uniform or varying dimensions in width (best illustrated in FIG. 1) and thickness (best illustrated in FIG. 12) between the base 2421 and the apex 2422 of the corner protrusion 2420. For example, the corner protrusions 2420 may include a thickness defined between the inner and outer surfaces that varies with the height as measured from the base 2421 to the apex 2422) of the protrusion 2420, such as being thicker (or thinner) at the base 2421 of the corner protrusion 2420 as compared to the thickness closer to the apex 2422 of the corner protrusion 2420. By way of another example, the width, which is generally perpendicular to the thickness, may be wider (or narrower) at the base 2421 of the corner protrusion 2420 as compared to width near the apex 2422 of the corner protrusion 2420. For example, in the illustrated embodiment the thickness of the corner protrusions at the apex is 1.09 millimeters and at the base is 1.14 millimeters.

In the illustrated embodiment, the pattern of elevated interconnected walls 2430 employs a repeating hexagonal external and internal shape. However, it should be understood that other shapes may be employed. For example, the pattern of elevated interconnected walls may be comprised of any pattern including any arrangement of shapes such as a square, an octagon, a pentagon, a rectangle, a triangle, a circle, a hexagon, or a heptagon, or a combination thereof. It should also be understood that the walls may be arranged in a random pattern. It should also be understood that the walls 2430 may have a greater density in number or composition in one region versus another region. For example an increased or decreased density (either in composition or in number of the walls) may be employed around or near apertures.

In the illustrated embodiment, the interconnected walls 2430 are oriented into hexagonal formations (or portions of a hexagonal formation) that together create a honeycomb wall pattern. The honeycomb pattern may be uniform or non-uniform. The apertures 2440 in the second layer 2400 and the plurality of protrusions 2320 of the first layer 2300 have corresponding hexagonal shapes that are dimensioned to snugly mate together, so that one, some, or all six of the hexagonal walls are in contact with one another. The pattern of elevated interconnected walls 2430 may, as previously noted, be contiguous or dis-contiguous, and may or may not extend to the perimeter regions of the second layer 2400, may be positioned in discrete regions, or may be spaced apart. Various patterns comprising one or more shapes may be employed alone or in combination with other patterns. The elevated pattern of interconnected walls 2430 may be configured in height and construct so as to suspend the back face of the mobile device above the apertures 2321 defined by one or more of the interconnected walls 2430 so that the back face 2120 of the mobile device 2100 does not bottom out on the recessed inner surface 2410 of the second layer 2400.

The second layer 2400 may further comprise one or more button protrusions 2450 that are dimensioned and configured to extend within one or more of the control apertures 2530 of the third layer 2500. Each button protrusion 2450 may or may not be co-molded to the corresponding control aperture 2530 to form an integrated region therewith. The button protrusions are generally configured to reside above a user control button on the mobile device 2100 such as a volume 2132, power 2152, mute, or other user buttons.

The third layer 2500 may also further is one or more retention or stability tabs 2550 configured to extend underneath the back face 2120 of the mobile device 2100. The inner surface of the tab may be in contact with the outer surface of the second layer, while the outer surface of the tab may be exposed externally. The tab 2550 may be received within an aperture 2350 on the first layer 2300 that opens to the perimeter. The tab 2550 and aperture 2350 may be configured to reside closer to one end of the mobile device 2100 than the other, and may be configured to reside closer to one side of the mobile device than the other.

The third layer 2500 may also be configured to include retention rim 2214 positioned to reside over the perimeter region 2170 of the front face 2110 of the mobile device 2100 to assist in retaining the mobile device 2100 within the case 2200. The retention rim 2214 may encircle a portion or the entire front face 2110. For example the retention rim 2214 may be configured to extend at the top, bottom left and/or right sides (at the corners or along the sides thereof) of the mobile device in any combination thereof.

The case 2200 is configured and constructed with sufficient flexibility to allow a user to install and remove the mobile device 2100 within the case without damaging the case or the mobile device. The flexibility may be implemented via the construction materials employed and the configuration of the layers or components.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required it one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

While the above detailed description has shown, described, and pointed out novel features as applied to various embodiments, it will be understood that various omissions, substitutions, and changes in the form and details of the embodiments illustrated may be made without departing from the spirit of the disclosure. As will be recognized, certain embodiments of the inventions described herein may be embodied within a form that does not provide all of the features and benefits set forth herein, as some features may be used or practiced separately from others.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Similarly, the disclosure is not to be interpreted as reflecting an intent that any claim set forth below requires more features than are expressly recited in that claim. Rather, as the following claims reflect, inventive aspects may reside in a combination of fewer than all features of any single foregoing disclosed embodiment.

Each of the foregoing and various aspects, together with those set forth in the claims and summarized above or otherwise disclosed herein, including the figures, may be combined without limitation to form claims for a device, apparatus, system, method of manufacture, and/or method of use.

All references cited herein are hereby expressly incorporated by reference.

1. A protective case for a mobile device configured to be in contact with all sides of a mobile device, wherein the mobile device has a flat front surface, a flat back surface, and side surfaces extending between the front and back surfaces, the protective case comprising:
a flexible inner sleeve configured to engage and surround a mobile device, including the back surface and the side surfaces of the mobile device, the flexible inner sleeve comprising a front surface, a back surface, and side surfaces extending between the front and back surfaces, including top, bottom, right, and left side surfaces, the flexible inner sleeve further comprising an indention extending continuously from the back surface to the top, bottom, right, and left side surfaces of the flexible inner sleeve, wherein the height of said indention on at least one of the top, bottom, right, and left side surfaces of the flexible inner sleeve, as measured between the front and back surfaces, is less than the height of the indention extending on one or more of the other sides of the flexible inner sleeve, and wherein the flexible inner sleeve further includes a protrusion configured to overlie in contact with a control button on the mobile device; and
a rigid outer shell releasably engaged with the flexible inner sleeve to thereby form an integrated protective unit, wherein the outer shell is configured to reside within the indention, wherein the outer shell includes an aperture dimensioned to receive the protrusion, wherein the outer shell includes multiple side walls that are configured to reside within the corresponding portions of the indention that are located on the side surfaces of the inner sleeve, and wherein at least one side wall of the outer shell is configured to reside entirely below the front surface of the mobile device when the mobile device is fully inserted within the protective case such that the back surface of the mobile device is in contact with the flat back surface the flexible inner sleeve.

2. The protective case of claim 1, wherein when the outer shell is engaged with the flexible inner sleeve the case has an exposed edge of the flexible inner sleeve extending beyond the outer shell that surrounds and thereby defines a screen opening.

3. The protective case of claim 1, wherein the flexible inner sleeve comprises a soft polymeric material.

4. The protective case of claim 3, wherein the soft polymeric material is selected from the group consisting of a silicon based polymer, a foamed polymer, or rubber.

5. The protective case of claim 1, wherein the outer shell comprises a hard plastic material.

6. The protective case of claim 5, wherein the hard plastic material comprises acrylic.

7. The protective case of claim 1, wherein when the outer shell is engaged with the flexible inner sleeve, the case has an exposed edge of the flexible inner sleeve not covered by the outer shell that surrounds and thereby defines the aperture.

8. The protective case of claim 7, wherein the second exposed edge includes a curved region.

9. The protective case of claim 1, wherein each of the top, bottom, right, and left sides of the flexible inner sleeve includes one or more apertures, and wherein the outer shell also includes one or more apertures that correspond to the one or more apertures of the top, bottom, right, and left sides of the flexible element.

10. the protective case of claim 1, wherein the flexible inner sleeve is configured to be removable from the outer shell.
